(19) United States
(12) Patent Application Publication
(10) Pub. No.: US 2007/0050238 A1
(43) Pub. Date: Mar. 1, 2007

(54) Computer-implemented apparatus and method for capturing and monitoring employee development and performance in a call center

(76) Inventors: Michael Carr, Dallas, TX (US); Sidney Morgan, Jacksonville, FL (US); Tina Cummings, Jacksonville, FL (US); Joel Spurling, Jacksonville, FL (US)

Correspondence Address: VESNA N. RAFATY, 18926 CAMPBELL ROAD, DALLAS, TX, 75252, US

(21) Appl. No.: 11/218,409

(22) Filed: Sep. 1, 2005

(51) Int. Cl. G06F 11/34

(52) U.S. Cl. 705/11

(57) ABSTRACT

An interactive computer-implemented apparatus and method for capturing and monitoring performance in a call center, and for promoting competition in productivity and quality metrics among employees comprising: a relational database, for use by all employees in the call center, comprising a competencies module defining competency requirements for each job in the call center, an individual employee development plan module linked to the competencies module a performance appraisal module for automatically calculating an overall performance rating for each employee, and a query and reporting facility, a database of employee demographic information, functional knowledge database comprising pre-defined employee functional knowledge elements required across all job codes of the call center organization; a competencies database comprising the organization's pre-defined employee competencies, the competencies linked to strategic goals of the call center organization, each competency assigned one or more proficiency levels, each proficiency level comprising one or pre-defined milestones, each job code assigned a targeted competency proficiency level; a development plan database for capture of employee-inputted development goals for one or more competencies, development goals selected from milestones per the competencies database, the selected development goals reviewed by a supervisor; a performance appraisal database for capture of the employee's supervisor-inputted performance ratings for a specified period, the performance ratings comprising distinct components of quality, productivity, and behavior, the behavior component further comprising a development rating, the development rating based on the employee's attainment of one or more employee's development goals per the development plan database, the rating for each component assigned a weight, the weight being a percentage of the maximum merit increase rate, the overall performance rating being the sum of the performance ratings for each component, the overall performance rating used to calculate the employee's merit increase, a periodic performance review database for capture of supervisor-inputted information from periodic performance reviews held with an employee, and a reports facility comprising instructions enabling administrators, employees, and supervisors to query one or more databases, the reports facility generating viewable and printable reports on-demand.

### BACKGROUND

The disclosed invention is directed generally to computer-implemented systems for management of employee performance in an organization. More specifically, the disclosed invention is directed to interactive computer-implemented tools for capturing and monitoring employee performance in a call center organization which automate certain aspects of the employee performance appraisal process and which promote alignment of all employees with the strategic goals of the call center organization.

A typical call center entity comprises agents (teleworkers) who routinely and primarily directly interact with customers over the telephone, agents (non-teleworkers) who provide services to customers and do not routinely interact with customers over the telephone, teams which comprise one or more agents possessing a similar set of skills (hereinafter “functional knowledge”), teams comprising one or more agents who provide services to a specific group of customers, and supervisors who oversee the operation of one or more teams. For purposes of this specification, the terms ‘agent’ and ‘employee’ are used interchangeably.

Tools which enhance the employee performance appraisal process by enabling the creation of electronic employee performance appraisal are known (see for example, U.S. Pat. No. 6,754,874 issued to Richman). Various known systems for capturing and optimizing call center operational performance are also known. For example, U.S. Pat. No. 6,603,854 issued to Judkins, et al., is directed to a method of improving operational performance in a call center entity. Known is U.S. Pat. No. 6,606,480, to L'Allier. et. al., entitled “Automated system and method for creating an individualized learning program.” Also known are various software products which are directed to enhancement of traditional human resource functions in an organization such as employee evaluation and appraisals, employee training and development, and employee recruitment. Known examples of such software products are People-Trak Human Resource Information Systems (www.people-track.com; Corporate Renaissance Group emPerform (www.crgroup.com), Intelesoft Technologies, Inc. HRintelesoft (HRi); www.recruitmax.com; HRsmart, Inc., talent management solutions (www.hrsmart.com); Enkata Technologies Contact Performance Suite and Contact Improvement Application. Note that the applicant's knowledge of the preceding software products is limited to knowledge that can be gleaned from a review of the promotional literature publicized for the products.

However, there is no known prior art which provides for a call center organization entity a multi-purpose computer-implemented tool, simultaneously driven the products.

However, there is no known prior art which provides for a call center organization a multi-purpose computer-implemented tool, simultaneously driven by agents, supervisors, and administrators, for capturing and monitoring agent and team performance via comprehensive modules which link the organization's functional knowledge requirements, competencies requirements for all employee job codes periodic employee performance review processes, pay-for-performance processes employee's individual development planning processes and individual employee performance metrics in a way that enables supervisors to readily identify top performers facilitates the creation of individual employee development plans linked to the organization's pre-set strategic goals and encourages employees to compete with call center teammates in performance metrics linked to the organization's strategic goals.

The preferred embodiment for the disclosed invention is an application for a call center organization. However, it will be obvious to one of ordinary skill in the relevant art, that the disclosed apparatus and method are applicable in any organization which has employees delivering services to customers, where the organization desires to measure and monitor its employee's quality of service and employee productivity, and/or where the organization desires to align development of its employees with strategic goals of the organization.

It is an object of the disclosed invention to provide a computer-based tool for a call center entity to help align all employees to focus on pre-defined (quality and productivity) performance metrics and to drive continuous improvement in such metrics, in part by promoting competition within a team by enabling each employee to query the tool on demand and generate, view, and print a graph showing the employee's performance metrics vs. performance metrics of his/her team members.

It is an object of this invention to provide a computer-based tool for a call center entity to help promote a 100% cross-trained workforce, in part by providing a real-time electronic record, accessible to all employees, depicting on a single computer screen a comprehensive listing of pre-defined employee functional knowledge required for the organization to do its business, a check beside each listed functional knowledge currently possessed by the employee, and a blank by each listed functional knowledge currently not possessed by the employee, the latter representing a training opportunity for the employee.

The preferred embodiment of the disclosed invention [Another object of the disclosed invention is to provide a computer-based tool for a call center entity which] enables a human resources manager or other administrator to readily monitor the organization's employee performance review processes to ensure that supervisors in different teams are using consistent language in giving performance feedback to employees who have comparable overall (numeric) performance ratings.

The preferred embodiment of the disclosed invention [It is also an object of the disclosed invention to provide a computer-based tool for a call center entity which] automatically calculates an overall (numeric) performance rating for each employee, based on ratings input by the employee's supervisor, where the performance rating incorporates both quality and productivity metrics, and furthermore where the quality metric incorporates a measure of the employee's progress in achievement of a personal development goal, the goal selected by the employee (and approved by his/her supervisor) from a database of pre-defined organizational competencies linked to the employee's job code and the strategic goals of the organization. The ready availability of a real-time overall performance rating for each employee [

Another object of the disclosed invention is to provide a computer-based tool for a call center entity which] enables management to easily [readily] identify the top performers in the organization, thus enabling frequent and timely recognition of top performers, including a means whereby the supervisor can query the application tool on a daily basis to identify employees who are celebrating a birthday and/or anniversary on that day.

Per an optional feature of the preferred embodiment, the overall employee performance rating incorporates [An object of the disclosed invention is to provide a computer-based tool for a call center entity which automatically calculates and displays in real-time a current overall performance rating for each employee based on supervisor inputs of employee ratings in attendance, professionalism, development, productivity, and] an organization-wide metric relating to customer satisfaction based on periodic customer surveys conducted by the call center entity.

[An object of the disclosed invention is to provide a computer-based tool for a call center entity which automatically calculates and displays in real-time a merit pay increase for employees for a given cycle based on user inputs of employees current salary, the budgeted maximum merit pay rate, and the employees' tool-calculated overall performance ratings.]

A feature of the preferred embodiment enables [Finally, an object of the disclosed invention is to provide a computer-based tool for a call center entity whereby a] enables a supervisor to [can] query the application tool and [to] generate a report identifying [whereby the supervisor can readily identify] employees, organization-wide, who possess the requisite functional knowledge for a current task requiring resource allocation, and then select and allocate from among those employees an employee having the highest quality of service rating as displayed in the report.

### SUMMARY OF THE INVENTION

What will be described herein is an invention which delivers each of the functionalities [(objects)] listed above which set the disclosed invention apart from the known prior art. The focus herein is on the required functionalities of the invention. It will be obvious to one of ordinary skill in the programming art how to write computer source and/or object code to deliver the desired functionalities as described herein. The preferred embodiment of the disclosed invention for a call center entity comprises a web-enabled software application, hereinafter referred to as “Tool,” which comprises a large relational database comprising smaller distinct tables or databases (herein sometimes referred to as “modules”), procedures and subroutines of the modules which incorporate certain rules associated with each data field of the modules and which manipulate the data in the data fields, and an on-demand report-generation engine (hereinafter “Reports Facility”), all of which reside on a Microsoft SQL (Structured Query Language) Server. A relational database is a computerized compilation of data organized into tables, each table having columns with column headings representing various data attributes. Tables that share at least one attribute in common are “related,” thus the term “relational database.” An important aspect of the disclosed invention is that the Tool is designed to be readily accessible to all employees and provides for inputs by non-supervisory employees, supervisors, and administrators (including Human Resources Department as well as executive management). In this way, the Tool engages the entire organization in the performance management of the call center. The Tool integrates employee productivity metrics, measured using external tools such as ACD system, with the other features and functionalities of the Tool. The Tool is web-enabled and has an assigned URL address. Users access the Tool by providing a pre-assigned User ID and User Password. The Tool may be hosted or it may reside on the organization's proprietary servers. The preferred embodiment of the disclosed invention was written in .NET language; however, alternative platforms are possible and are within the scope of this invention. The preferred embodiment of the disclosed Tool is deployed in an ASP architecture.

The modules of the disclosed relational database capture and store data attributes either via direct input by a user or via an external feed whereby data are imported into the databases from an external source such as Human Resource Department (hereinafter “HR”) software products and call center operational performance measuring tools (e.g., E-Talk, CenterVu, ACD (automatic call distributor) systems).

The categories of employee-based data attributes captured, manipulated, and managed by the various modules which comprise the relational database of the Tool are the following: employee-identifying information or demographics (e.g., name, unique ID number associated with the employee, employee active status indicator, address, job code, assigned team, birthdate, hire date, pay grade classification, highest completed educational level, current supervisor and previous supervisors, six-sigma rating (if any), current salary), employee's current job-specific skills (herein referred to as functional knowledge), verified by the employee's supervisor, employee-inputted individual development goals, supervisor inputted textual data capturing periodic one-on-one employee performance reviews (including supervisor comments relating to the employee's current calls and claims-processing productivity metrics, quality metrics, listing of E-learning classes completed). In addition, the disclosed Tool captures (via administrator inputs) and manages certain organization-based data attributes: competencies and competency levels, linked to job codes, the competencies directly based on the organization's strategic goals, with statements of possible milestones within each competency level, pay grade salary ranges including midpoint, and an organization-wide customer satisfaction score (derived from periodic customer surveys). Examples of the types of manipulations performed by the Tool on the data attributes listed above are the following: automatic calculation of the overall numeric performance rating for each employee, and automatic calculation of each employee's merit pay increase based on a formula which incorporates the employee's overall performance rating (as automatically calculated by the Tool) and the administrator-inputted overall budget for merit pay increases. A reports engine is also provided whereby all users, including non-supervisory employees, may query the entire relational database that comprises the Tool, per authorizations and rules which depend from the user's functional role in the organization, specify pre-defined query terms and view and print the report or graph which is the query result.

### DETAILED DESCRIPTION OF THE INVENTION

Copyright Notice: Certain information disclosed in this specification, including the drawings below which show sample computer screens, is protected by the U.S. Copyright laws and copyright owner, Accelerated Performance Resources, LLC, reserves all rights therein.

The disclosed invention comprises a software application, hereinafter referred to as “Tool,” which is web-enabled, such that a user, via a browser on the user's computer, accesses the URL of the Tool in order to access and run the application. A prototype of the disclosed invention was written in .NET, a Microsoft product which is a tool set providing operating system support routines. The discussion below and associated headings will help explain the multi-purpose features of the disclosed Tool.

Users/User Interfaces

The user entities of the disclosed invention include all employees of the call center organization and are broadly categorized as follows: the Tool Administrator(s), agents who are non-supervisory employees, and supervisory employees. The Administrator may be but does not need to be a managerial employee in the HR Department of the organization. The Administrator may be an individual in the organization who has the responsibility to maintain the disclosed tool and to monitor its overall operation. Subject to the user's Tool access privileges (see below), the user interfaces with the Tool via various computer screens which are templates for entry of data per screen prompts and which display current data residing in the fields.

Roles-Based Access

The disclosed Tool captures, manipulates, displays, and prints on-demand certain employee performance-related information. Users of the Tool are employees of the organization at every level of the organization. Thus, users may be managerial, supervisory, or non-supervisory employees. The user's functional role in the organization determines what data are accessible to that user. Each employee can view his/her data, data for his/her direct reports (if the employee is a supervisor), and data for subordinates of the direct reports, and so on. In addition, through special reporting functions per the Reports Facility, a user, including a non-supervisory employee, can generate a graph which is a comparative plot of the user's performance metrics versus those of other employees which comprise the user's team. The administrator entity has authority and capability to access the entire database and has special functional capabilities as discussed below under Administrator Menu.

Per an optional feature of the disclosed invention, a current supervisory employee who is an employee's former supervisor is given authority to access and view that former employee's performance appraisal generated per the Tool. This feature supports 360-degree evaluation of an employee's performance, helps encourage employee development, and, over times, also serves an internal control to calibrate the employee appraisal process.

Upon accessing the application's URL and typing a User ID and User Password, the user sees the Main Menu Screen, the starting point for the user's interaction with the Tool. The Main Menu per the preferred embodiment displays tabs which the user may click to access the following modules and their associated functionalities: Demographics, MBO, Competencies, Behavior, Training Portfolio, Calls Effectiveness, Functional Knowledge, Claim Counts, IDAP, Performance Appraisal, Administrator Functions, Reports and Tools, Supervisor Budget, Training Details. The Tool also has a keystroke-saving feature whereby on the left side of each computer screen of the Tool, the user selects an employee name by clicking on a name which is shown in the scrolling list of all employees in the organization.

Demographics

The Demograhics Module per the preferred embodiment of the Tool comprises the following data fields: a unique number assigned to each employee, the Associate ID, employee name, team name, indicator whether employee is in a supervisory role (drop down), the employee's current Behavior Score (retrieved from the Performance Appraisal Module), indicator whether employee is a teleworker (teleworkers may thus be identified and assigned different performance metrics from non-teleworker employees), active status box (Boolean check box), current salary. The Tool also links a job code with one or more competencies, per the strategic vision of the organization.

Competencies Module

An important feature of the disclosed invention is the Competencies Module which encompasses a competencies dictionary or Table of Competencies and its associated links and subroutines. The Competencies Module is accessible to all employees. Importantly, the Competency Module is tied to the Development Module. Within the Development Module (IDAP), each employee selects, by reference to the Competencies Module, a Development Goal, a specific competency within which the employee desires to attain a higher level of performance. Thus, the Competencies Module helps to focus each employee on specific competencies for his/her current job and serves as a guide to the employee for achieving a higher level of competency in that job.

The Table of Competencies represents the organization's pre-defined listing of names of competencies, competency definitions, one or more competency level designations within a given competency, and statements (herein called “bullets”) for each competency level describing specific behavioral milestones required for attainment of the given competency level. The organization specifies competencies which are aligned with the strategic goals of the organization. The Administrator populates the Table of Competencies via direct input of the data. The Administrator has authority to modify, add, or delete competencies in the Table of Competencies. The Tool links each job (via the Job Code) with one or more competencies which are deemed to be necessary and appropriate for the given function performed in the job. So a job has one or more competencies assigned to it. Similarly, each job is assigned a target proficiency level. This feature is useful to the employee in identification of his/her specific development goals on his her Development Plan (IDAP). So for example, if an employee's goal is to attain proficiency level (TPL) 2 for the competency of “Communication,” which is assigned to his/her job code, per the preferred embodiment of the Tool, one bullet, i.e., development goal for the IDAP, for that employee is the following: “Select the most suitable method of communication to deliver a message based upon the audience and the situation.”

By way of example and not by way of limitation, sample competencies, per the preferred embodiment of the Tool, include the following: collaboration/relationship building, communication, customer focus, diversity, decision-making ability, delegation-ability, creativity and innovation, attention to detail, results orientation, teamwork, analytical thinking, and vision/sense of purpose. By way of example and not by way of limitation, the competency of The preferred embodiment of the Tool has competencies are directed to the quality of the employee's performance, as differentiated from productivity metrics of performance. The Tool also links

Functional Knowledge

The Tool has a pre-defined Functional Knowledge Table, viewable by all users, listing all of the organization's pre-set and pre-defined functional knowledge elements (i.e., substantive skills) required of employees in order for the organization to deliver services to its customers. Administrators directly input information into the Functional Knowledge Table and are typically the sole users authorized to modify the data as required. The Functional Knowledge Record is an electronic, visual inventory of the employee's current functional knowledge. Supervisors typically are granted the authority to access and update or modify their subordinate's Functional Knowledge Record. Each employee can view his/her current Functional Knowledge Record. The administrator typically is granted authority to input/modify/update the Organizational Functional Knowledge Table.

A feature of the Tool is the Functional Knowledge Finder Module whereby a supervisor may query the Tool to find out which employees possess a specific functional knowledge. The Functional Knowledge Finder assists the supervisor in allocating resources based on the demands of the workload. Thus, via the Functional Knowledge Finder subroutine, the supervisor specifies query terms via keystroke-saving drop down boxes which list the possible choices for each query term. So, for example, the supervisor may query the Functional Knowledge Finder to search for employees who possess functional knowledge required for a specific customer group (HMO, for example, if the call center is in the health insurance industry) which serves health care providers) and a specific substantive skill/skill subset within the selected customer group. The Functional Knowledge Finder routine then searches the entire Tool to deliver search results in the form of a viewable, printable report. The report displays at least the following information for the search results meeting search criteria: employee name, name of the employee's supervisor, date hired, and the employee's current performance metric (herein called the Behavior Score and discussed below) relating to quality of performance. The supervisor then selects an employee from the names listed on the report and contacts that employee's supervisor to see whether the employee is available to be allocated to the current demand.

Training Portfolio Module

The Training Portfolio Module captures information relating to the employee's organizational learning. Supervisors or administrators may input data into the Training Portfolio Module and the data may then be reviewed by employees. A user who accesses and employee's Training Portfolio sees a display of the following data: highest completed educational level (via manual input by checking a selection in the Drop Down Box of pre-defined options, or imported from HR records; editable only by the Administrator); listing of completed training classes, herein called “E-learning” (may be imported from HR records or manually input in freeform); the employee's current Six Sigma Rating (as appropriate), based on the employee level of completed training in a pre-defined Six Sigma Training Program, and a box called ‘Opportunities’ where the supervisor may freeform input recommended possible future organization learning opportunities for the selected employee (training programs; future job positions).

Individual Development Action Plan or IDAP

The preferred embodiment of the disclosed invention has a feature within the so-called Individual Development Action Plan Module (IDAP Module), whereby an employee may readily and efficiently create an electronic record of his/her individual development plan for later review with his/her supervisor. In this way, the employee can assume greater ownership of his development. By accessing the IDAP tab of the Main Menu of the Tool, an employee may create, view, modify, update, and/or print his/her individual development plan. One of the unique features of the disclosed Tool is that the Competencies Module described above helps the employee to easily create his/her individual development plan. Via the Table of Competencies, the employee knows which competencies are required for his her job code and also knows the target proficiency level for each competency. Then, knowing his/her current proficiency level, as rated by his/her supervisor, the employee selects his/her next targeted proficiency level for each competency required for his job code and then also selects one or more bullets for the selected proficiency level from the Table of Competencies. The selected bullets are the employee's development actions to be input in his/her IDAP. Per an optional keystroke and time-saving feature, the employee may “cut and paste” his/her selected milestones from the Table of Competencies and import them into his/her IDAP while creating the IDAP record.

MBO

The call center organization per the preferred embodiment requires each supervisor to meet in person with each employee on his/her team at least once per month to discuss the employee's performance. That meeting is herein referred to as an ‘MBO’. The Tool enables a supervisor to generate an electronic record of the MBO via the MBO Module. The MBO Module allows an employee to view his/her MBO's. Each MBO is identified with a Title which is usually the month the MBO was conducted. Additionally, the Title field has a Drop Down Box which allows the supervisor to select “Coaching” or “Corrective Action,” indicating that that the particular MBO was non-routine and represented a step in the disciplinary process which was initiated for the employee.

The MBO Module has the following data fields: Title, refers to the Month of the MBO, Date Created, i.e., the date (month/day/year) the supervisor started to create the electronic record of the MBO (the Tool automatically captures Date Created as the date that the supervisor hit the ADD key to create the MBO record), Date Completed, the date that the supervisor manually inputs as the date (month/day/year) he/she actually conducted the MBO; Production, a field, Quality, E-learning and Opportunities. Once the supervisor inputs a Date Completed, the MBO record is fixed and uneditable, even by the Administrator.

Reports Facility

The Reports Facility of the disclosed Tool provides a means for users, including non-supervisory employees, to generate certain reports on demand. The Reports Facility enables the user to query the entire relational database of the Tool, specify certain pre-set query terms, and then view and print if desired a report which displays current data attributes for the selected query terms. The types of reports are the following: Calls Effectiveness vs. Quality, Claims Effectiveness vs. Quality, Calls Time Usage, Claims Counts, Employee Detail Report, MBO Report, Functional Knowledge Finder, Training Finder, Anniversary Finder, and Birthday Finder. The Employee Detail Report is a useful feature for supervisors because the supervisor will specify one or more employees to search and will also specify what data (e.g., Behavior Score, Demographics, IDAP, MBO, Functional Knowledge, Training, Performance Appraisal) he/she wants to view for the selected employee or employees. The Tool then generates a viewable and printable report of the selected data for each selected employee, consistent with the supervisor's access privileges. Per the Claims Effectiveness v. Quality tab of the Reports and Tools tab of the Main Menu, a user, even a non-supervisory employee, may specify query terms, his team and a start and end period for the report, and the Tool will generate a viewable and printable scatter plot diagram showing the user's claims effectiveness metric vs. those of his team members.

Behavior Scores

The disclosed Tool captures for each employee so-called Behavior Scores (or behavior ratings) which are the employee's supervisor-inputted numeric ratings in the areas of schedule adherence (attendance), professionalism, and development. Thus, as example and not by way of limitation, possible ratings for schedule adherence are given on a scale of 1-5 with 5 being given for perfect attendance. Possible ratings for professionalism may be on a scale of 1-5 where 5 means outstanding professionalism. The development component is a rating based on the employee's level of attainment of development goals per the employee's IDAP. Thus, for example, an employee who has created an IDAP for the current review cycle, but has not completed progress on any bullet per that IDAP may be assigned a development rating of 1. An employee who has not created an IDAP for the current review cycle gets a development rating of 0. An employee who has created an IDAP for the current review cycle and has completed 2 bullets per that IDAP gets a rating of 3. The Tool displays the employee's current Behavior Scores on the Performance Appraisal Screen.

Overall Performance Rating

The disclosed Tool automatically calculates and displays in real-time under the Performance Appraisal tab of the Main Menu, a numeric performance rating for each employee representing the overall performance rating for the current review cycle. The components of the overall performance rating are the following: organization score, individual performance scores (quality, effectiveness), and Behavior Scores (as explained above). The performance rating is used to calculate the employee's merit pay increase or percentage. The organization score as used herein refers to a call center-wide quality of performance rating (usually given as a percentage out of a possible rating of 100%) per periodic customer surveys conducted by the call center entity. The organization score thus is the same for each employee of the call center and is directly input into the Tool by the individual designated and authorized to do data entry. Thus, for example, if an employee's component ratings per the Performance Appraisal Module add up to 75%, then the employee's merit pay is calculated according to the formula: 75% of 6% (where 6% is the maximum authorized merit pay increase) or 4.5%.

Pay for Performance-Related Features

The disclosed Tool automatically calculates a merit pay increase for each employee based on the employee's calculated merit rate increase (based on the performance rating per above) and the employee's current salary as displayed in the Salary data field of the Demographics Module.

A cross-check feature in the Tool checks compares the figures in the Salary field with the MidPoint (for the job pay classification of the employee according to the following rule: If the figure in the Salary field is greater than the figure in the MidPoint field, then the Tool does not calculate a merit increase for the employee and instead a lump sum payment amount is input.

Administrator Menu

The administrator plays an important role in the start-up (initial population of input of certain data fields as discussed), operation, and surveillance (compliance reviews) of the disclosed Tool. A user who is an administrator has access to and performs the following functions as depicted by tabs on the Admin Menu Screen of the preferred embodiment for the Tool: Competencies Administration, Employee Administration, Job Classification Administration, Team Administration, Functional Knowledge Administration, Customer Satisfaction Administration, Job Code/Competency Linkage, Ranges Administration (pay ranges, midpoints for each job code), User Administration, Salary/Merit Conversions, Admin Tasks, and Admin Years, and Recalculate Global Budget. The administrator performs important data entry functions during the start-up phase of the Tool and also plays an important role in the continuing maintenance of the Tool, including data (Table of Competencies, Table of Functional Knowledge, pay grade-related updates, linkage of job codes and competencies, etc.) updates as appropriate.

The administrator can audit the Tool for example to see whether IDAP's and MBO's are being created and completed as required. The administrator can audit the performance review process for consistency in the way supervisors across teams are rating employees. This is a type of calibration of the performance review processes of the organization. So, for example, employees from different teams who have equal or similar overall performance ratings should have similar textual input (comments and feedback) from their supervisors, as evidence on the employees' MBO's.

Productivity Ratings: Calls Effectiveness and Claims Effectiveness

Call centers typically measure and monitor agent productivity by measuring, for each pre-defined period, using tools such as the ACD systems and other systems, the number of calls handled by an agent, the number of hours available to the employee for handling calls, the number of written pieces (i.e., “claims” in a health insurance industry call center) processed, the hours available, and a calculation of productivity (herein referred to as “effectiveness”) with respect to each. The Calls Effectiveness Module per the preferred embodiment of Tool, for example, displays for each employee the employee's current quality score (as per a measuring tool that is external to the Tool), and an Organization Score for the overall organization and thus the same for each employee, based on periodic customer surveys conducted by the organization. The Calls Effectiveness Module allows a user to view and print productivity-related metrics for a selected employee by specifying a month and year. The Calls Taken shows number of calls completed, productive hours, effectiveness rating, s, and taken effectiveness. A useful feature of the disclosed Tool is that it enables employees to query the Tool, per the report facility, to compare the employee's current performance metrics with those of his team. That feature is herein referred to as a performance comparison report.

### DRAWINGS

FIG. 1 is a computer screen of the Main Menu per the preferred embodiment.

FIG. 2 is a computer screen showing the Reports and Tools screen per the preferred embodiment;

FIG. 3 is a computer screen showing search results per Functional Knowledge Finder module per the preferred embodiment;

FIG. 4 is a computer data screen showing a sample Behavior Score screen per the preferred embodiment;

FIG. 5 is an example of the rules governing data fields in the MBO Module per the preferred embodiment;

FIG. 6 is the Employee Detail Report Screen per the preferred embodiment;

FIG. 7 is a computer data screen of a periodic performance review (MBO) per the preferred embodiment;

FIG. 8 is a computer data screen of the Admin Menu per the preferred embodiment

FIG. 9 depicts a sample performance comparison report

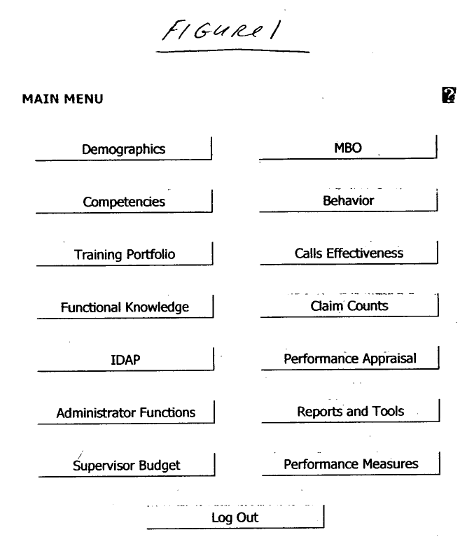

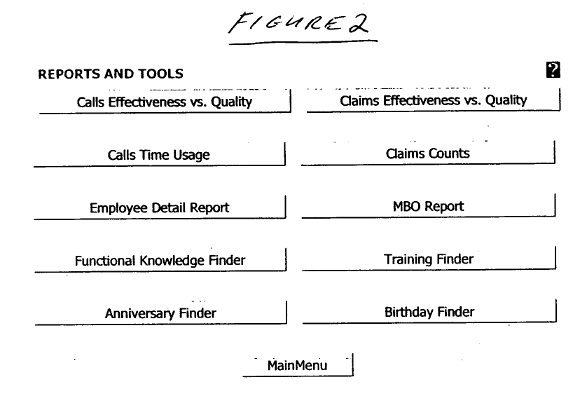

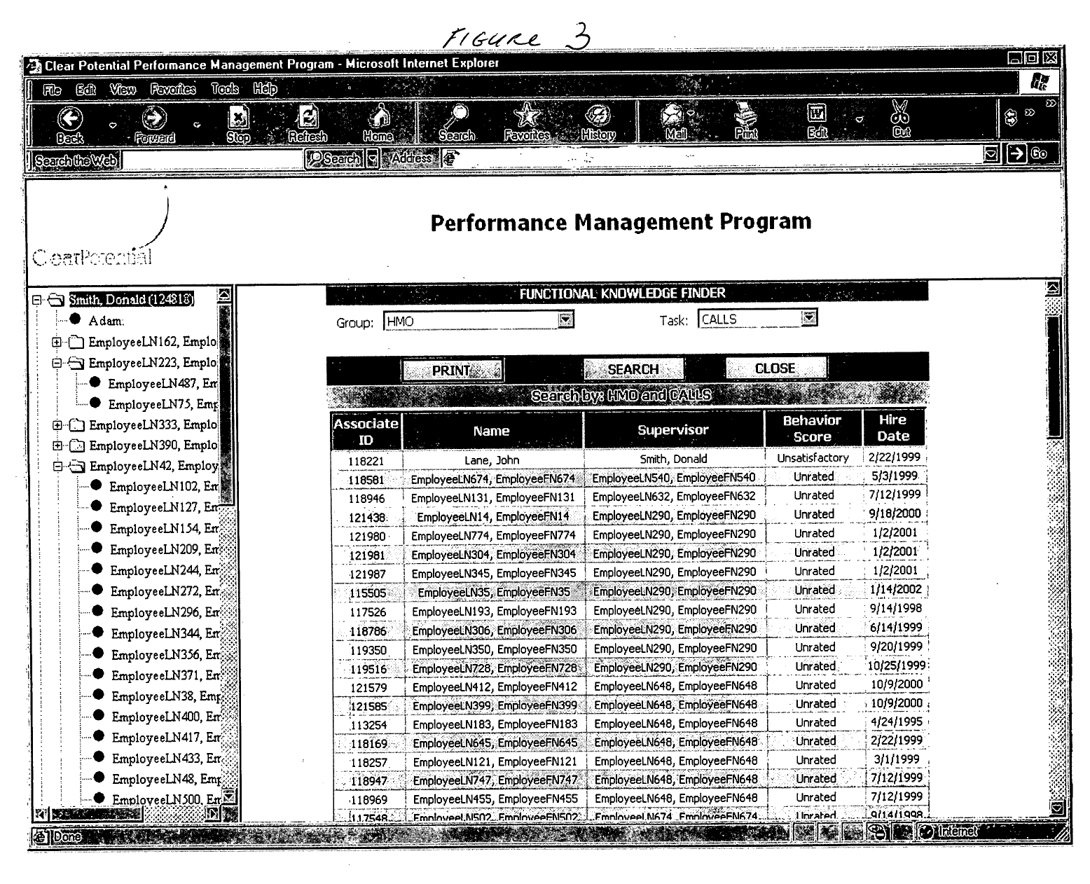

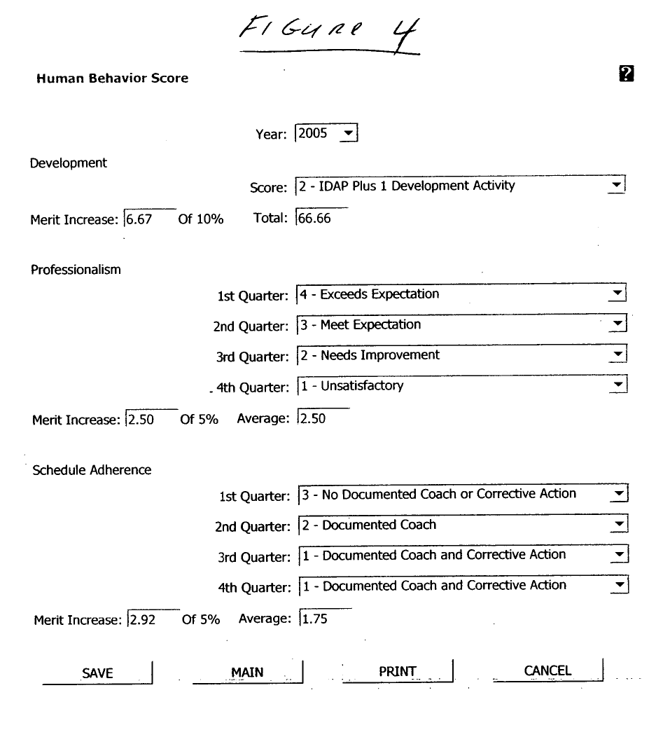

### DESCRIPTION OF THE DRAWINGS

The figures provided, along with the description of the invention, help teach the functionalities and the making of the disclosed Tool. The figures, which represent computer data screens per the preferred embodiment are self-explanatory.

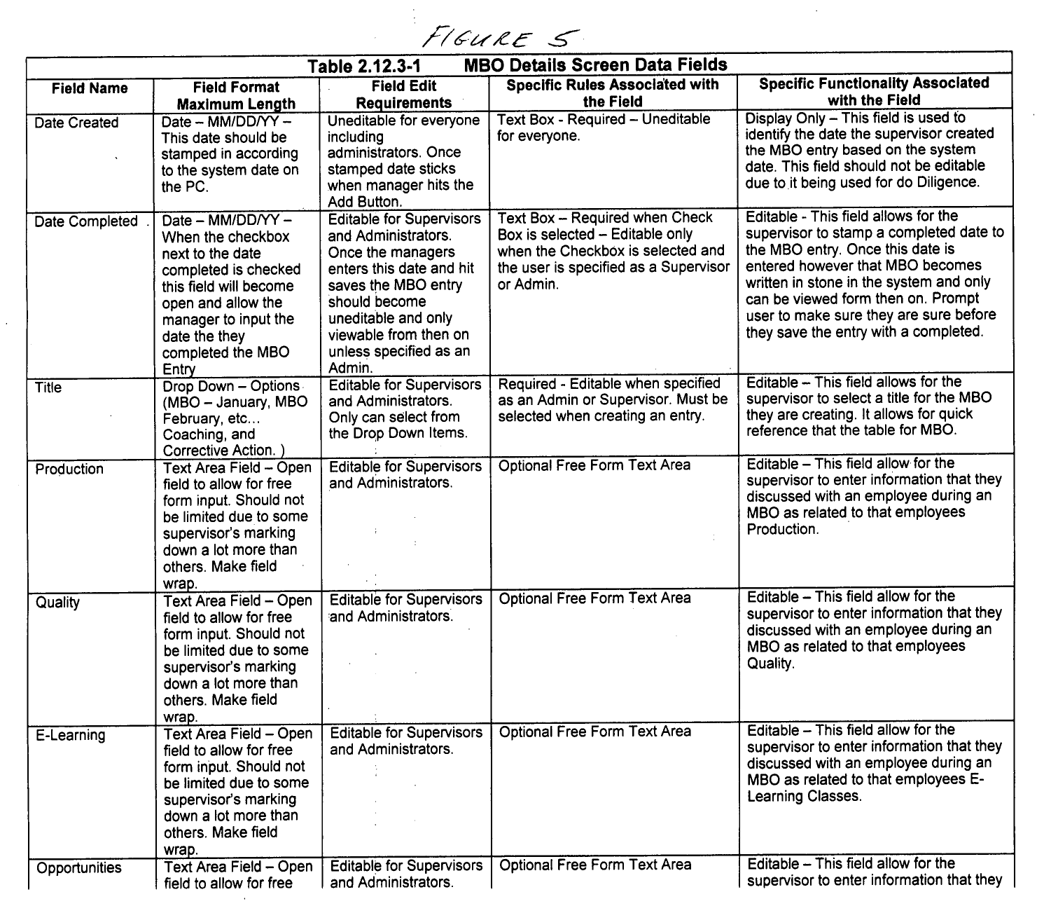

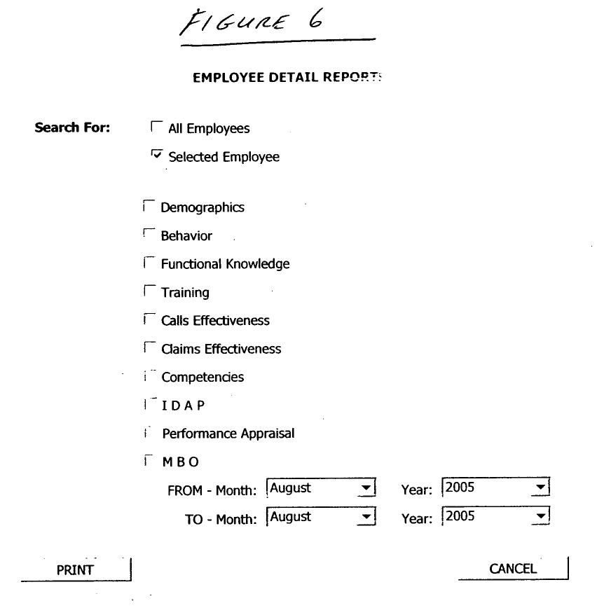

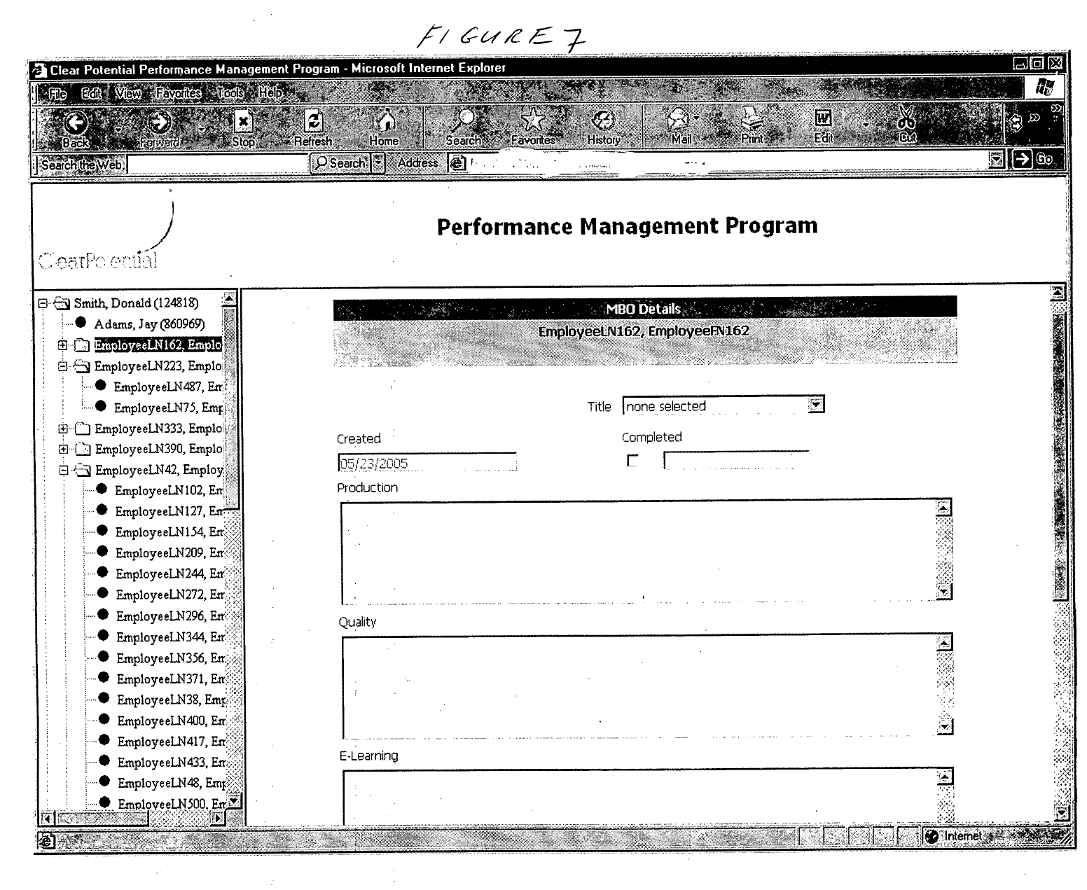

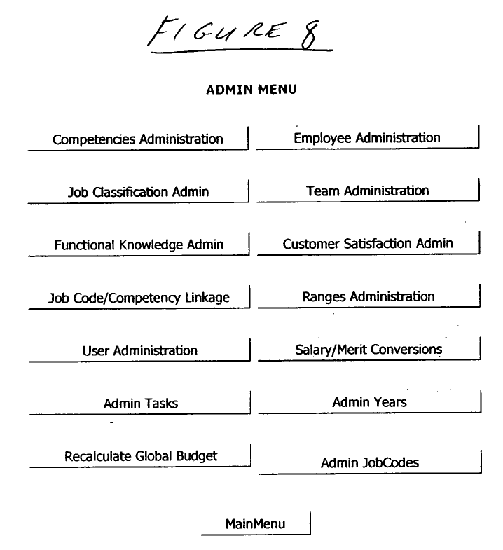

FIG. 5 is a computer screen which summarizes for the selected employee data relating to the employee's quality (as opposed to productivity) of performance or Behavior Score. Shown are the current values for the three components of the Behavior core per the preferred embodiment, namely development, professionalism, and schedule adherence. Thus, per the preferred embodiment, the Development Score, IDAP Plus 2, indicates that the selected employee has fully attained development outcomes per his individual development plan. That is, the employee specified two development goals and has attained both. Note that alternative ways to designate ratings are of course possible and are considered to be within the scope of this invention. The screen also shows the weight (percentage of 100% of the overall performance rating) assigned to each component of the Behavior Score for purposes of merit calculation. So, by way of example and not by way of limitation, per the preferred embodiment the development rating is weighted as being equivalent to 10% of the overall performance rating.

FIG. 9 shows a sample performance comparison report per the preferred embodiment of the disclosed invention. The employee conducted a reports facility query specifying a beginning and ending rating period and performance metrics to be compared, namely claims effectiveness and quality. The performance comparison report that results from that query displays a scatter plot graph showing the employee's current ratings in the selected performance metrics vs. that of each member of his team.

I claim:

1. An interactive computer program product in a computer-readable medium in a computer, for use by administrators, non-supervisory employees, and supervisors, in accordance with their respective pre-set access authorization, for capturing and managing performance in a call center organization comprising a relational database, the relational database comprising:
a demographics module database comprising a table of data attributes comprising of: employee name, supervisor name, call center team name, current salary, current job code, birthdate, hire date, designated maximum merit pay rate increase, the merit pay rate increase linked to the job code;
a functional knowledge module database comprising a table of organization-wide pre-defined employee functional knowledge elements, the functional knowledge elements linked to job codes;
a competencies module database, accessible to all employees of the call center organization, comprising a table of statements of the organization's pre-defined employee competencies, the competencies relating to strategic goals of the call center organization and linked to job codes, each competency assigned one or more proficiency level, each proficiency level comprising at least one or more pre-defined milestone, each job code assigned a targeted proficiency level;
an individual development plan module database comprising a data entry template prompting an employee to input one or more development goals for one or more competencies, competencies selected from competencies linked to the employee's job code per the competencies database, development goals selected from milestones for competencies per the competencies database;
a performance appraisal module database, comprising instructions for a data entry template for prompting supervisors to input employee performance ratings in pre-defined components of performance, and instructions whereby an overall numeric employee performance rating is automatically calculated and displayed, the template creating a retrievable, viewable record of the employee's performance ratings for a specified period, the performance ratings comprising distinct component ratings of quality, productivity, and behavior, the behavior rating component further comprising ratings in attendance, professionalism, and development, the development rating based on employee's attainment of one or more development goals per the individual development plan database, the rating for each component assigned a weight, weights of all component ratings totaling 100%, the overall performance rating comprising the sum of the ratings for each component, the employee's merit pay increase automatically calculated using the employee's overall performance rating;
a periodic performance review module database comprising instructions for a data entry template prompting a supervisor to input information from a periodic performance review held with an employee, the completed template creating a retrievable, viewable periodic performance review record, the template capturing data comprising the date the supervisor conducted and completed the periodic performance review and the supervisor's comments relating to the employee's performance productivity, quality, training, or future job opportunities,
and
a reports facility comprising instructions enabling administrators, employees, and supervisors to query one or more databases comprising the relational database, according to the user's pre-set access authorization, the reports facility generating viewable and printable reports on-demand,
the reports comprising a functional knowledge finder report whereby a user selects one of the functional knowledge elements as a query search term and the functional knowledge finder report displays a table of data attributes including employee name, employee hire date, employee's supervisor name, and employee's current behavior ratings for each employee who possesses the selected functional knowledge element,
the reports further also comprising a performance comparison report, whereby an employee specifies a performance component as a query search term and the performance comparison report displays a pictorial representation of the employee's current rating in that performance component versus that of the employee's team, calls effectiveness supervisor name, hire date, and behavior rating, the behavior rating representing the employee's

2. A method for promoting encouraging competition among employees and teams in a call center organization, and encouraging performance-related discussions between employees and supervisors in a call center organization, whereby an employee may compare on demand his/her performance ratings with those of his/her team members comprising the steps of:
a) providing accessing the computer program product per claim 1; and
b) training employees and supervisors in the proper use of the functionalities per the reports facility, including the performance comparison report, and encouraging employees to routinely utilize the functionalities, querying the reports facility specifying query terms: a begin period, an end period, a performance rating metric for the x-axis, and a different performance rating metric for the y-axis;
c) viewing the scatter plot graph that results from running the query and noting the employee's individual data point vs. that of the employee's team members.

3. A computer-interactive method of allocating at least one employee to a job in a call center organization based on the employee's current performance rating comprising the steps of:
(a) accessing the computer program product per claim 1;
(b) determining one or more functional knowledge elements required to perform the job;
(c) using the reports facility, generating a conducting a functional knowledge finder report, query of the relational database specifying one or more functional knowledge elements per step (b) as the query search terms;
(d) viewing the result of the query described in step (c), current combined rating in attendance, professionalism and development;
(e) selecting at least one employee from the query result based on the employee's behavior rating,
(f) contacting the supervisor of the selected employee to determine whether the selected employee is available for the job.

4. A method, using a computer, of monitoring the performance management processes in a call center organization for consistency in the way supervisors provide and document employee performance feedback, in call center organization that captures an overall performance rating for each employee, comprising the steps of:
(a) providing the computer program product per claim 1;
(b) accessing the computer program product per claim 1 and running a query in the reports facility, specifying query terms comprising: all employees from of at least two different selected teams;
(c) reviewing the results of the query per step (b);
(d) per the query results, identifying employees across more than one team who have equal or similar overall performance ratings;
(e) accessing and viewing the selected employees' periodic performance review records,
(f) for the selected employees, comparing supervisor-inputted data on the periodic performance review records representing supervisor comments relating to one or more of the following: employee's productivity metrics, employee's quality metrics, completed training, and future job or training opportunities.
(g) Reviewing and modifying as appropriate the organization's supervisor guidelines for conducting periodic performance reviews, the guidelines directed to promoting use of consistent language for employees having similar or equal performance ratings;
(h) Communicating guidelines developed per step (g) (f) to at least one supervisor.
